(19) United States
(12) Patent Application Publication
(10) Pub. No.: US 2019/0241141 A1
(43) Pub. Date: Aug. 8, 2019

(54) Occupant protection system

(71) Applicant: Saeid Sirous, Najaf abad (IR)

(72) Inventor: Saeid Sirous, Najaf abad (IR)

(21) Appl. No.: 15/890,460

(22) Filed: Feb. 7, 2018

(51) Int. Cl. B60R 21/02; B60R 21/01; B60R 21/0136; B60R 21/015; B60R 21/08; B60R 21/13; B60R 21/232; B60R 21/268; B60N 2/427

(52) U.S. Cl. CPC B60R 21/02; B60R 2021/23107; B60R 21/0136; B60R 21/01512; B60R 21/08; B60R 21/13; B60R 21/232; B60R 21/268; B60N 2/4279; B60N 2/42763; B60R 2021/01006; B60R 2021/01231; B60R 2021/01252; B60R 2021/01286; B60R 2021/0273; B60R 2021/0293; B60R 21/01

(57) ABSTRACT

In severe traffic accidents, crumpling the front of the car causes the passenger's leg get stuck between the seat and the car's dashboard. In this article, the condition of the seat and occupant safety sack is checked, which keeps the passenger in place, in heavy crashes, then raises the occupant's knee, and pulls the front seats back as far as possible.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

### U.S. Patent Classification

280/730.1; 180/274; 280/743.2

The crumple zone is a structural feature mainly used in automobiles and recently incorporated into railcars.

Crumple zones are designed to absorb the energy from the impact during a traffic collision by controlled deformation through Crumpling. This energy is much greater than is commonly realized. A 2,000 kg (4,409 lb) car travelling at 60 km/h (37 mph) (16.7 m/s), before crashing into a thick concrete wall, is subject to the same impact force as a front-down drop from a height of 14.2 m (47 ft) crashing on to a solid concrete surface. Increasing that speed by 50% to 90 km/h (56 mph) (25 m/s) compares to a fall from 32 m (105 ft)—an increase of 125%. This is because the stored kinetic energy (E) is given by E=(½) mass×speed squared. It increases by the square of the impact velocity.

Typically, crumple zones are located in the front part of the vehicle, in order to absorb the impact of a head-on collision, though they may be found on other parts of the vehicle as well. According to a British Motor Insurance Repair Research Centre study of where on the vehicle impact damage occurs: 65% were front impacts, 25% rear impacts, 5% left side, and 5% right side. Some racing cars use aluminum, composite/carbon fiber honeycomb, or energy absorbing foam to form an impact attenuator that dissipates crash energy using a much smaller volume and lower weight than road car crumple zones. Impact attenuators have also been introduced on highway maintenance vehicles in some countries.

Crumple zones work by managing crash energy, absorbing it within the outer parts of the vehicle, rather than being directly transferred to the occupants, while also preventing intrusion into or deformation of the passenger cabin. This better protects car occupants against injury. This is achieved by controlled weakening of sacrificial outer parts of the car, while strengthening and increasing the rigidity of the inner part of the body of the car, making the passenger cabin into a ‘safety cell’, by using more reinforcing beams and higher strength steels. Impact energy that does reach the ‘safety cell’ is spread over as wide an area as possible to reduce its deformation. Volvo introduced the side crumple zone with the introduction of the SIPS (Side Impact Protection System) in the early 1990s.

When a vehicle and all its contents, including passengers and luggage are travelling at speed, they have inertia/momentum, which means that they will continue forward with that direction and speed (Newton's first law of motion). In the event of a sudden deceleration of a rigid framed vehicle due to impact, unrestrained vehicle contents will continue forwards at their previous speed due to inertia, and impact the vehicle interior, with a force equivalent to many times their normal weight due to gravity. The purpose of crumple zones is to slow down the collision and to absorb energy to reduce the difference in speeds between the vehicle and its occupants.

Seatbelts restrain the passengers so they don't fly through the windshield, and are in the correct position for the airbag and also spread the loading of impact on the body. Seat belts also absorb passenger inertial energy by being designed to stretch during an impact, again to reduce the speed differential between the passenger's body and their vehicle interior. In short: a passenger whose body is decelerated more slowly due to the crumple zone (and other devices) over a longer time survives much more often than a passenger whose body indirectly impacts a hard, undamaged metal car body which has come to a halt nearly instantaneously. It is like the difference between slamming someone into a wall headfirst (fracturing their skull) and shoulder-first (bruising their flesh slightly) is that the arm, being softer, has tens of times longer to slow its speed, yielding a little at a time, than the hard skull, which isn't in contact with the wall until it has to deal with extremely high pressures. The stretching of seatbelts while restraining occupants during an impact, means that it is necessary to replace them if a vehicle is repaired and put back on the road after a collision. They should also be replaced if their condition has deteriorated e.g. through fraying or mechanical or belt mounting faults. In New Zealand it is officially mandatory to replace worn inertia reel type seatbelts only with ‘webbing grabber’ type belts that have less play and are more effective on older cars. Newer cars have electronically fired pre-tension seatbelts that are timed to work with the airbag firing. Buying used seatbelts is not a good idea even in countries where it is legal to do so, because they may have already been stretched in an impact event and may not protect their new users as they should.

The final impact after a passenger's body hits the car interior, airbag or seat belts is that of the internal organs hitting the ribcage or skull due to their inertia. The force of this impact is the way by which many car crashes cause disabling or life-threatening injury. Other ways are skeletal damage and blood loss, because of torn blood vessels, or damage caused by sharp fractured bone to organs and/or blood vessels. The sequence of energy-dissipating and speed reducing technologies-crumple zone-seat belt-airbags-padded interior, are designed to work together as a system to reduce the force of the impact on the outside of the passenger(s)'s body and the final impact of organs inside the body. In a collision, slowing down the deceleration of the human body by even a few tenths of a second drastically reduces the force involved. Force is a simple equation: Force=mass×acceleration. Cutting the deceleration in half also cuts the force in half. Therefore, changing the deceleration time from 0.2 seconds to 0.8 seconds will result in a 75 percent reduction in total force.

### ‘Sleds’ Inside Safety Cells

The 2004 Pininfarina Nido Experimental Safety Vehicle locates crumple zones inside the survival cell. Those interior crumple zones decelerate a sled-mounted survival cell. Volvo has also been developing this idea for use in small cars. Their driver's seat is mounted to what is basically a ‘sled’ on a rail, with shock absorbers in front of it. In an impact, the whole “sled” of driving seat and belted in driver, slides forward up to 8 inches, and the shock absorbers dissipate the peak shock energy of the impact, lengthening the deceleration time for the driver. Simultaneously, the steering wheel and the driver's side dashboard slide forward to make room for the driver, as he is thrown forwards stretching the seatbelt. Combined with a front crumple zone and airbag, this system could greatly reduce the forces acting on the driver in a frontal impact. (Wikipedia)

### BRIEF SUMMARY OF THE INVENTION

In severe traffic accidents, crumpling the front of the car causes the passenger's leg get stuck between the seat and the car's dashboard. In this invention, the condition of the seat and occupant safety sack is checked, which keeps the passenger in place, in heavy crashes, then raises the occupant's knee, and pulls the front seats back as far as possible.

### BRIEF DESCRIPTION OF THE SEVERAL VIEWS OF THE DRAWING

FIG. 1: Comparison of the performance of the occupant protection system.

FIG. 2: Component of occupant safety sack set.

FIG. 3: General arrangement for a vehicle with occupant protection system in normal mode.

FIG. 4: The first step of activation of the occupant protection system (side view).

FIG. 5: The second step of activation of the occupant protection system (side view).

FIG. 6: The third step of activation of the occupant protection system (side view).

FIG. 7: The first step of activation of the occupant protection system (front view).

FIG. 8: The second step of activation of the occupant protection system (front view).

FIG. 9: The third step of activation of the occupant protection system (front view).

FIG. 10: The first step of activation of the occupant protection system (isometric view).

FIG. 11: The second step of activation of the occupant protection system (isometric view).

FIG. 12: The third step of activation of the occupant protection system (isometric view).

FIG. 13: Method of work of the occupant protection system in frontal crash.

FIG. 14: Method of work of the occupant protection system in side crash.

FIG. 15: Method of work of the occupant protection system in roll-over crash.

FIG. 16: Method of work of the occupant protection system for rear occupants in frontal crash.

FIG. 17: General arrangement for the occupant protection system in normal mode for rear seats.

FIG. 18: General arrangement for the seat push-back system in normal mode (seat in headmost position).

FIG. 19: General arrangement for the seat push-back system in active mode seat (seat in rearmost position).

FIG. 20: Flowchart of occupant protection system.

### DETAILED DESCRIPTION OF THE INVENTION

### I. Invention Objective

The purpose of this plan is to reduce the severity of injuries to the occupant and the passenger's leg, in severe vehicle accidents.

### II. Description of Drawings and Parts

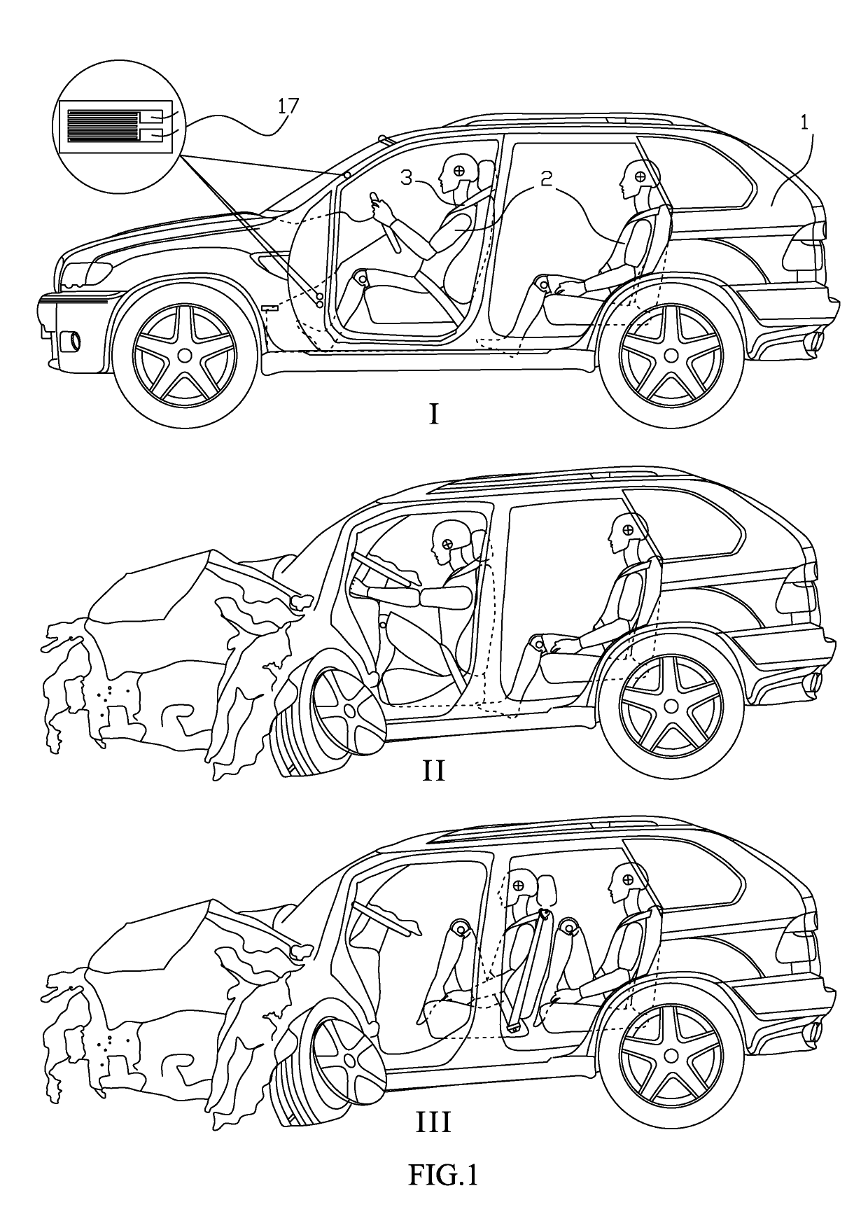

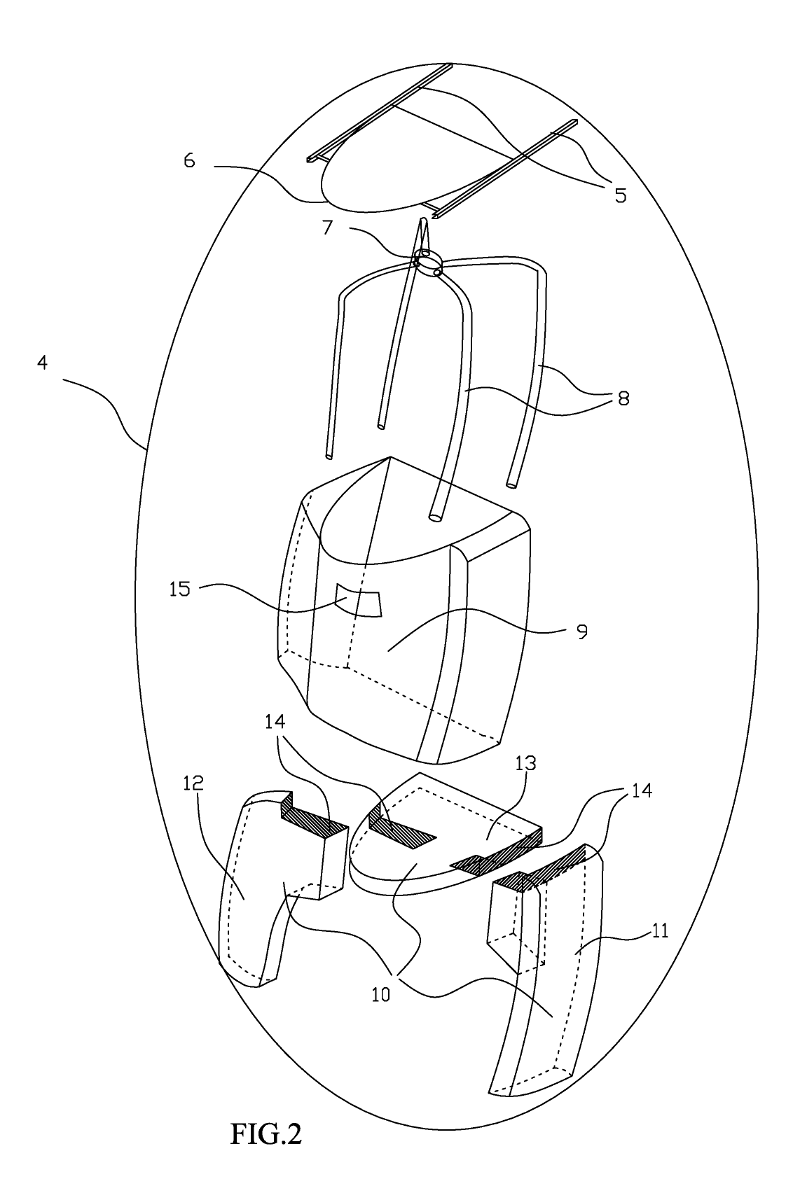

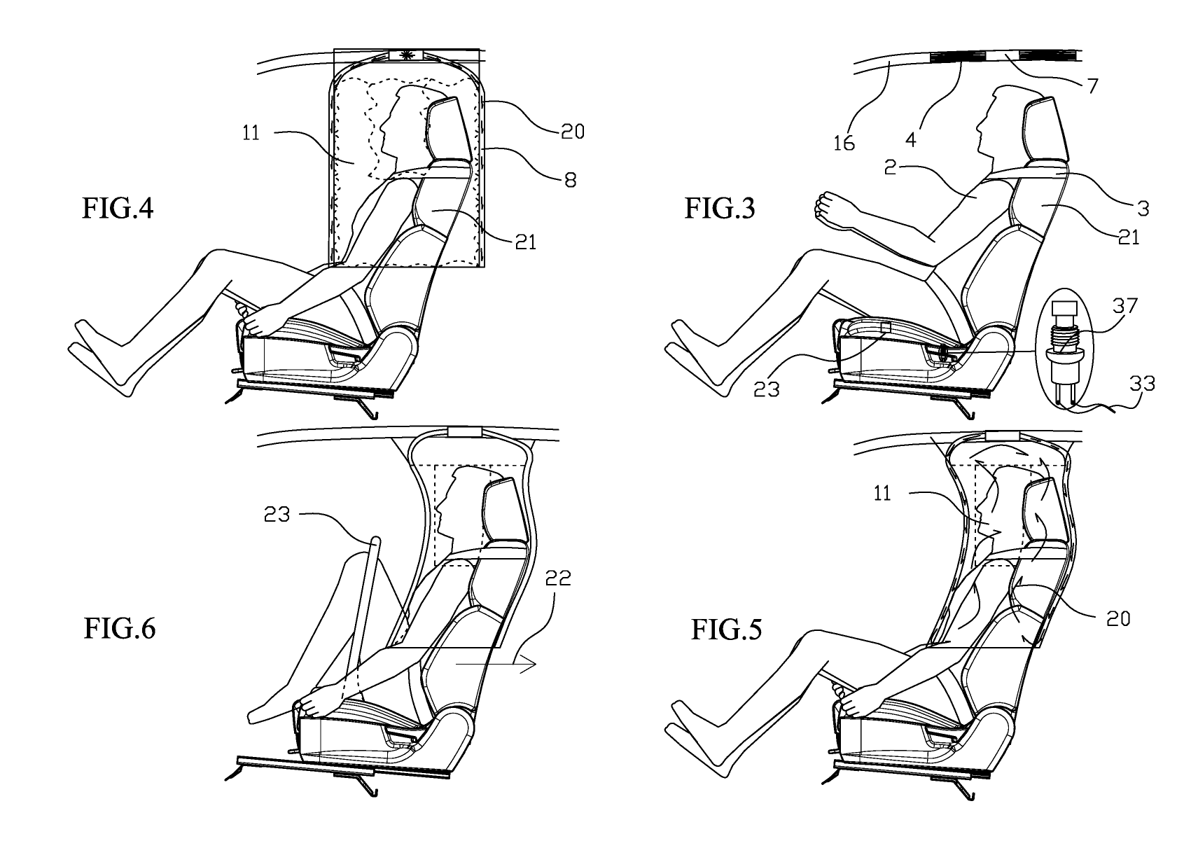

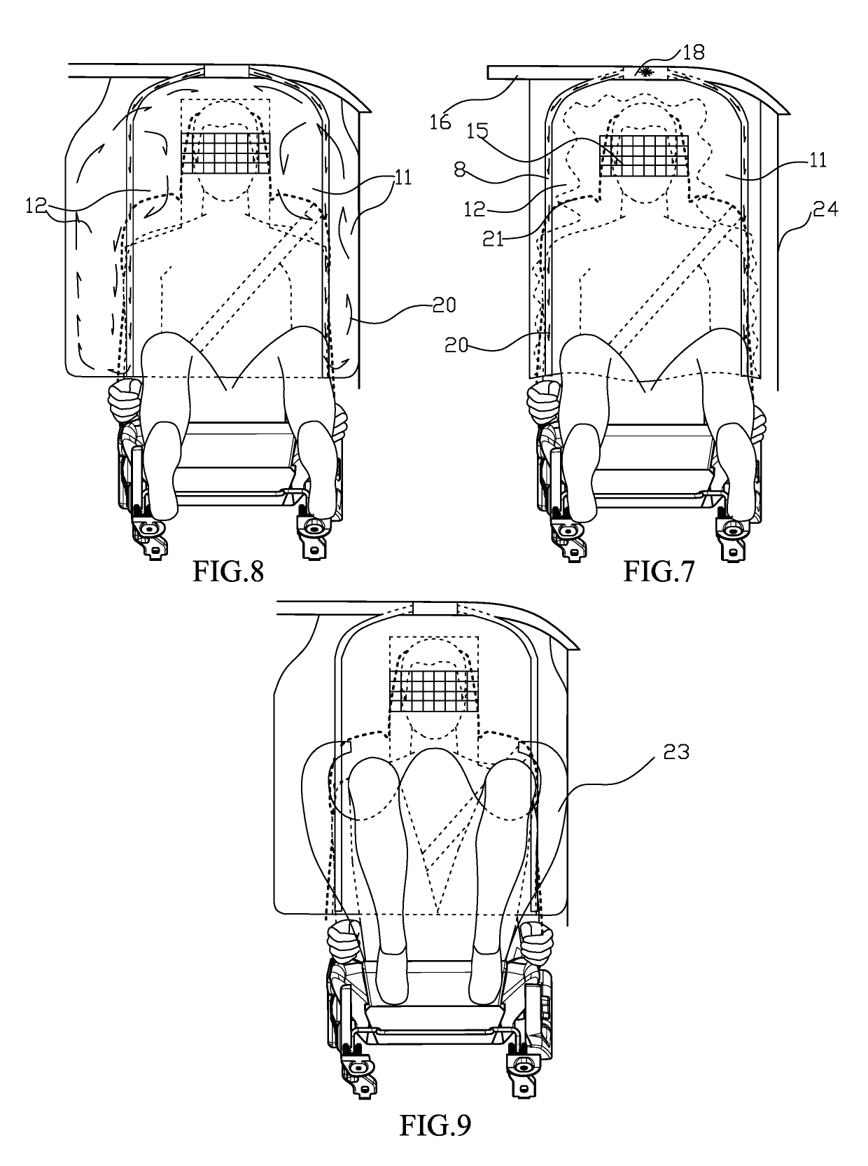

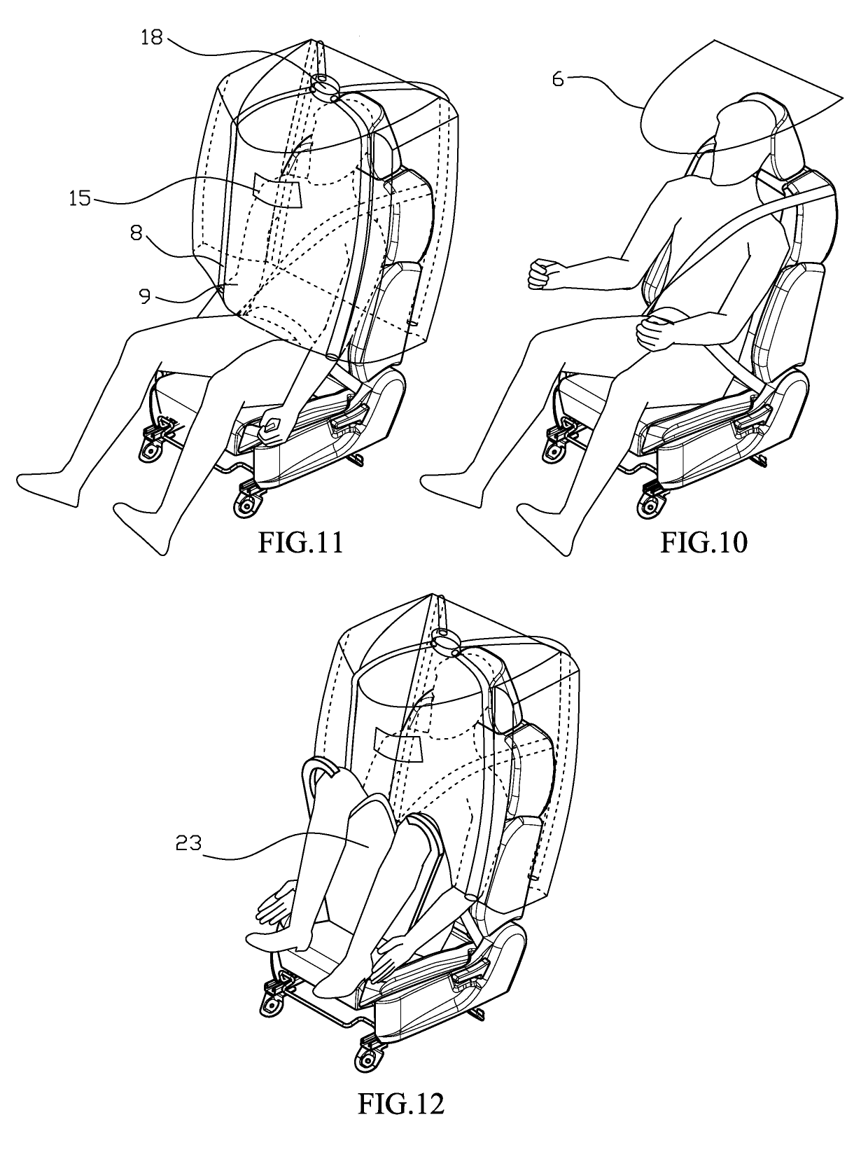

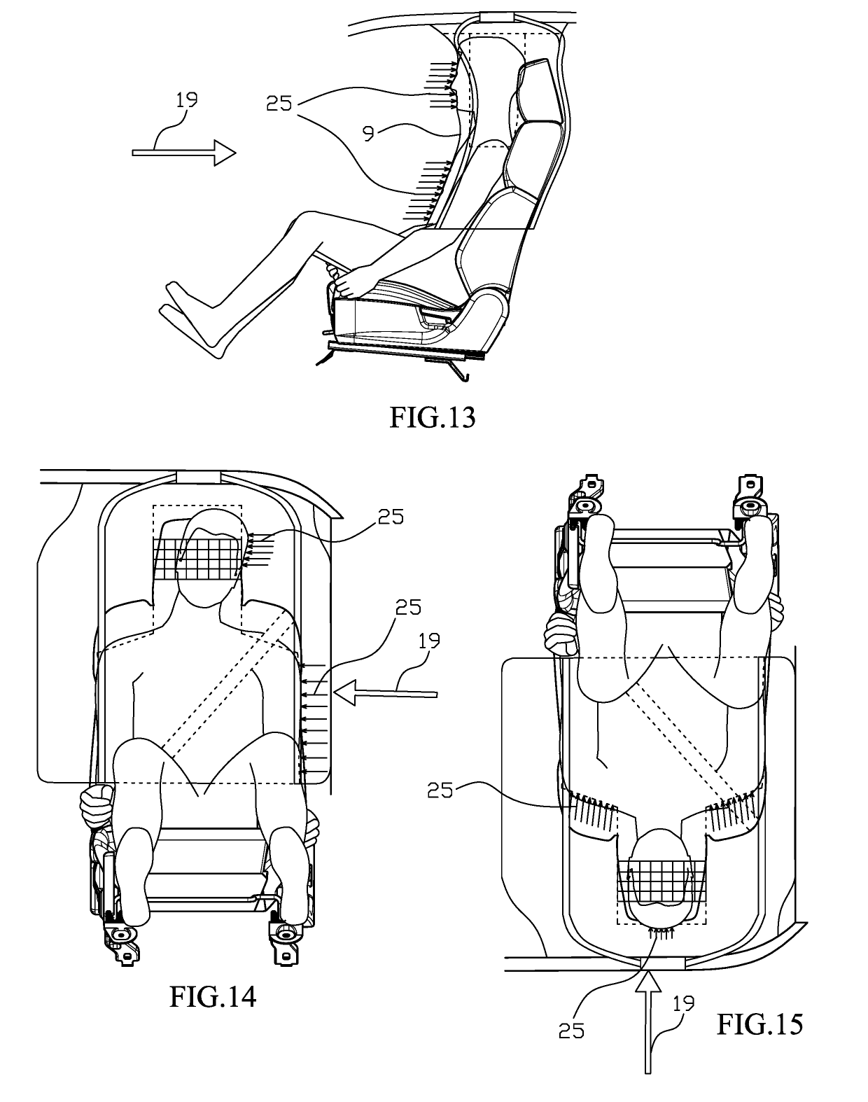

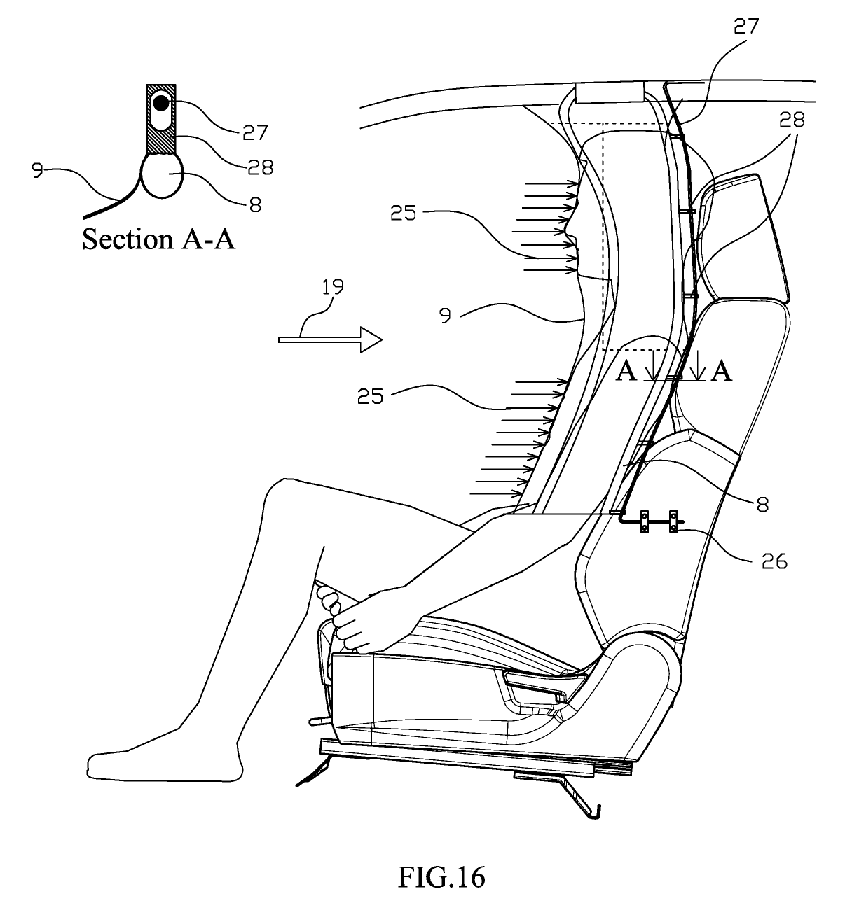

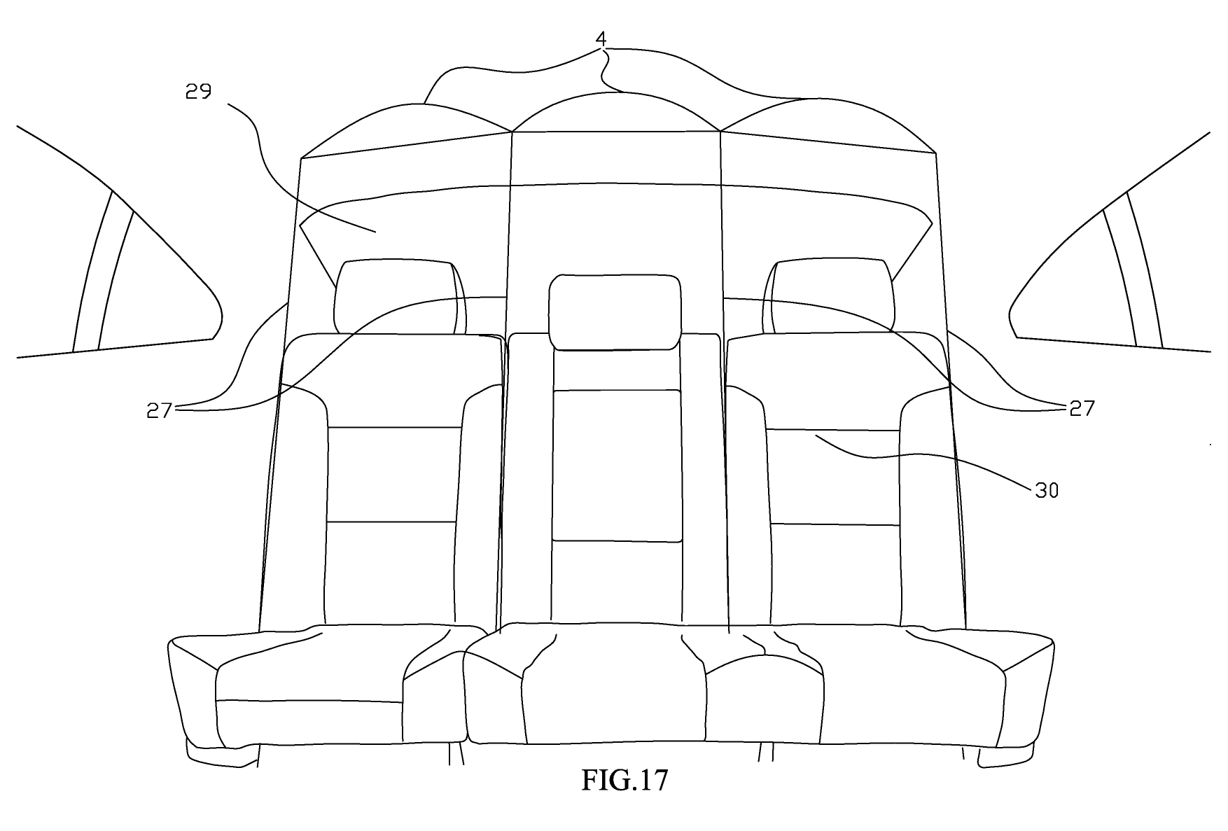

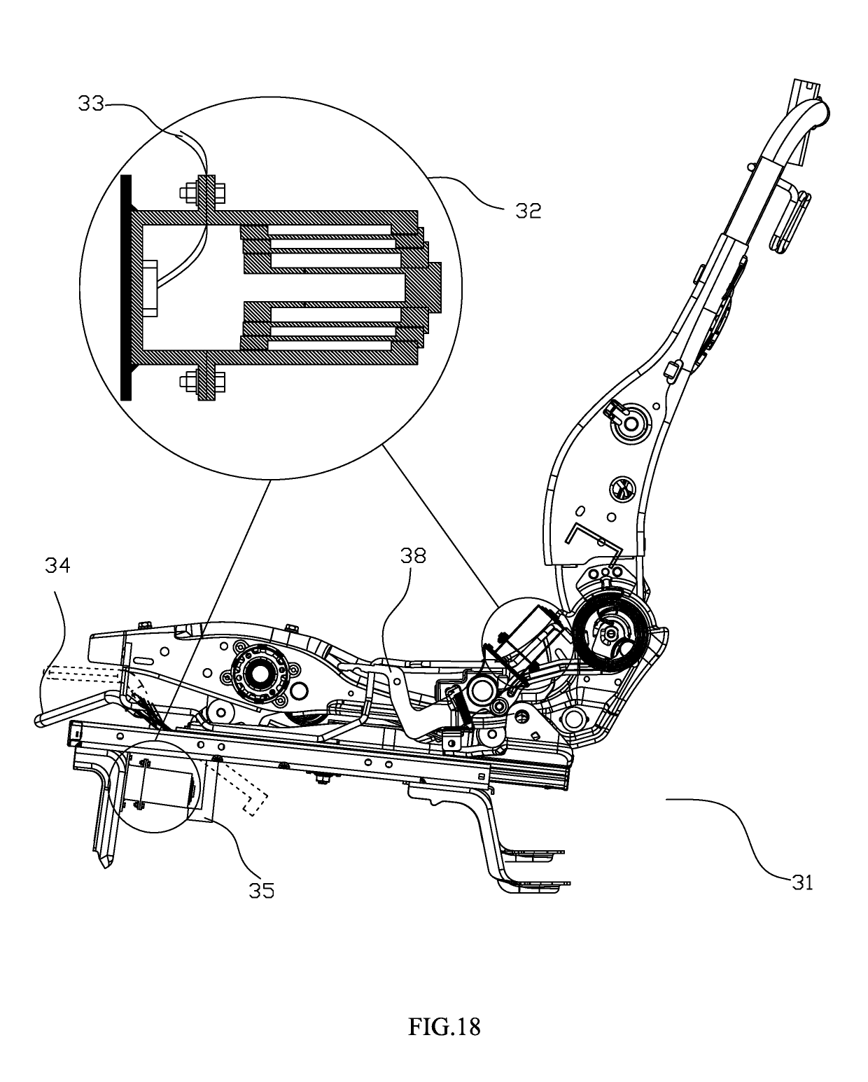

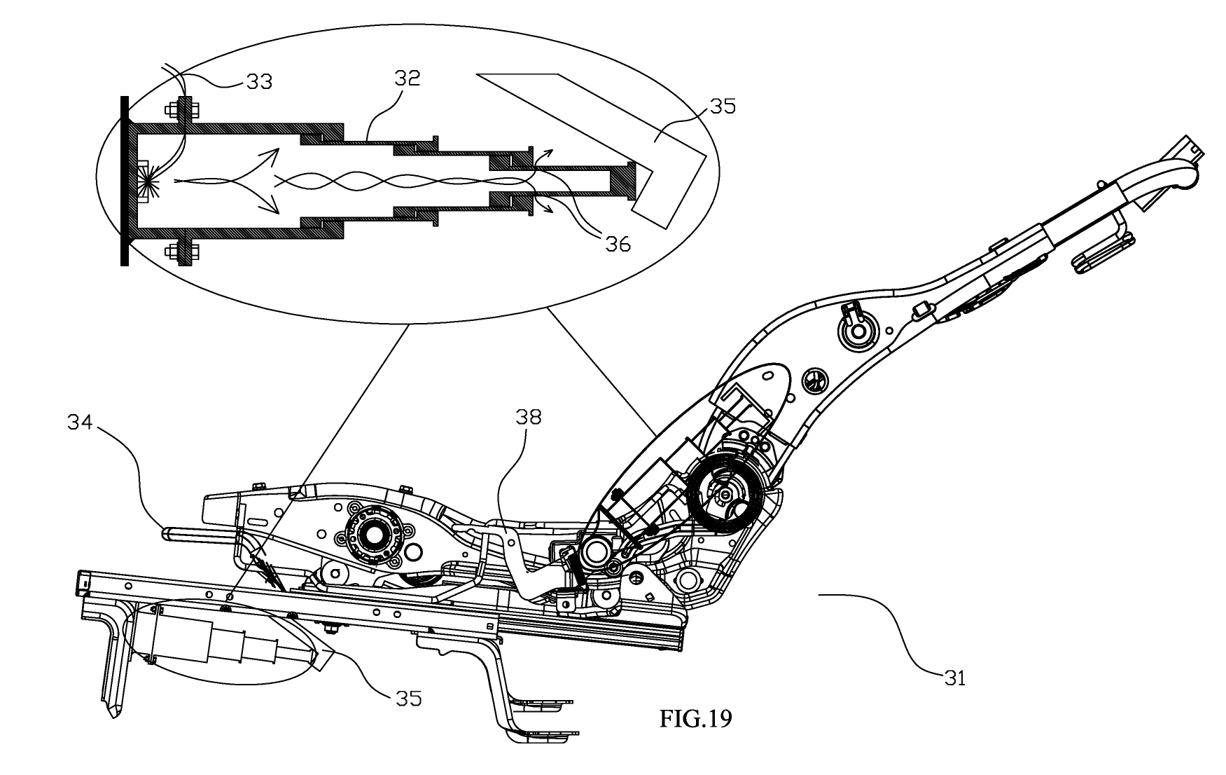

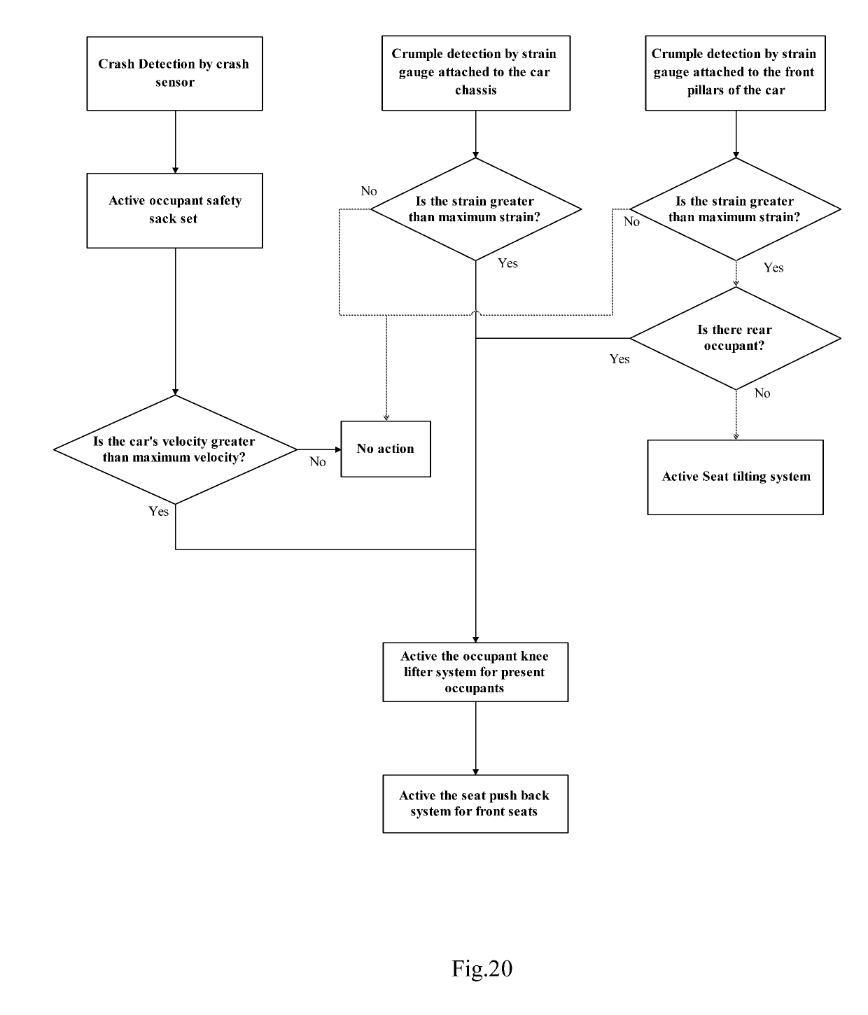

FIG. 1: Comparison of the performance of the occupant protection system. This figure is composed of:
1) Car
2) Occupant
3) Seat belt
17) Strain gauge
   FIG. 2: Component of occupant safety sack set. This figure is composed of:
4) Occupant safety sack set
5) Roof guide rails of occupant safety sack
6) Skid frame of occupant safety sack
7) Airbag inflator gas generator
8) Safety sack expander airbags
9) Safety sack
10) Airbags around the occupant
11) Airbag between the occupant and the door of car
12) Airbag between the occupants
13) Top head airbags
14) Airbags connection area
15) Mesh
   FIG. 3: General arrangement for a vehicle with occupant protection system in normal mode. This figure is composed of:
2) Occupant
3) Seat belt
4) Occupant safety sack set (retracted)
7) Airbags inflator system
16) Roof of the car
21) Front passenger seat
23) Occupant knee lifter airbag (retracted)
33) Connection wire to ECU
37) Push sensor
   FIG. 4: The first step of activation of the occupant protection system (side view). This figure is composed of:
8) Safety sack expander airbags
11) Airbag between the occupant and the door of car (retracted)
20) Gas flow path
21) Front passenger seat
   FIG. 5: The second step of activation of the occupant protection system (side view). This figure is composed of:
11) Airbag between the occupant and the door of car (inflated)
20) Gas flow path
   FIG. 6: The third step of activation of the occupant protection system (side view). This figure is composed of:
22) Seat move direction
23) Occupant knee lifter airbag
   FIG. 7: The first step of activation of the occupant protection system (front view). This figure is composed of:
8) Safety sack expander airbags
11) Airbag between the occupant and the door of car (retracted)
12) Airbag between the occupants (retracted)
15) Mesh
16) Roof of the car
18) Explosive chamber
20) Gas flow path
21) Front passenger seat
24) Door of car
   FIG. 8: The second step of activation of the occupant protection system (front view). This figure is composed of:
11) Airbag between the occupant and the door of car
12) Airbag between the occupants
20) Gas flow path
   FIG. 9: The third step of activation of the occupant protection system (front view). This figure is composed of:
23) Occupant knee lifter airbag
   FIG. 10: General arrangement for a vehicle with occupant protection system in normal mode (isometric view). This figure is composed of:
6) Skid of occupant safety sack
   FIG. 11: The second step of activation of the occupant protection system (isometric view). This figure is composed of:
8) Safety sack expander airbags
9) Safety sack
15) Mesh
18) Explosive chamber
   FIG. 12: The third step of activation of the occupant protection system (isometric view). This figure is composed of:
23) Occupant knee lifter airbag
   FIG. 13: Method of work of the occupant protection system in frontal crash. This figure is composed of:
9) Safety sack
19) Direction of applied force to the car
25) Force applied to the occupant from safety sack
   FIG. 14: Method of work of the occupant protection system in side crash. This figure is composed of:
19) Direction of applied force to the car
25) Force applied to the occupant from safety sack
   FIG. 15: Method of work of the occupant protection system in roll-over crash. This figure is composed of:
19) Direction of applied force to the car
25) Force applied to the occupant from safety sack
   FIG. 16: Method of work of the occupant protection system for rear occupants in frontal crash. This figure is composed of:
8) Safety sack expander airbags
9) Safety sack
19) Direction of applied force to the car
25) Force applied to the occupant from safety sack
26) Side guide rail bracket
27) Side guide rail of safety sack
28) Slider coupled to the safety sack expander airbags
   FIG. 17: General arrangement for the occupant protection system in normal mode for rear seats. This figure is composed of:
4) Occupant safety sack set
27) Side guide rail of safety sack
29) Rear glass of car
30) Rear seat of car
   FIG. 18: General arrangement for the seat push-back system and seat tilting system in normal mode (seat headmost position). This figure is composed of:
31) Structure of front seat
32) Pneumatic telescopic cylinder
33) Connection wire to ECU
34) Seat slider handle for occupant
35) Seat slider handle for push back system
38) Seat adjuster
   FIG. 19: General arrangement for the seat push-back system in active mode (seat rearmost position). This figure is composed of:
31) Frame of front seat
32) Pneumatic telescopic cylinder
33) Connection wire to ECU
34) Seat slider handle for occupant
35) Seat slider handle for push back system
38) Seat adjuster
   FIG. 20: Flowchart of occupant protection system.

### III. Terms and Definitions are Prerequisites

The minimum crumple speed that the front of the vehicle, up to the driver's feet: It's the minimum speed to get a ride-on collision from the front, allowing the car's dashboard to reach the driver's seat, whereas the seat at the headmost position. This speed is determined by the manufacturer in the crash test.
The minimum distance between the back of the front seat, up to the edge of the rear seat:
It has at least a gap, the backrest of the front seat can have the edge of the rear seat so that the foot of a human with a middle temper can move at this distance, and at the time of the incident, a rear occupant can get off the car without a problem. If occupant knee lifter is used, this distance can be considered null.
In this invention, the seat belt mounts on the seat, and moves forward and backwards with the seat, so that it does not lose its efficiency, when it comes forward and backwards in the seat, in the event of an accident.
   The cases of crashes that this invention can have at it:
A car crash, at speed greater than “minimum crumple speed of the front of the car, up to the driver's feet” with a fixed or moving object.
Vehicle crash, at a speed less than the “minimum crumple speed of the car, up to the driver's feet” with the moving object, which comes to the vehicle at speed (for example, a head-on collision).
Side collision
Car collision with the side of the truck or trailer, which is the height of the surface of the collision body, is above the vehicle's hood.
Car rollover

### IV. Description of the Invention

This invention consists of the following primary parts:
1. Crash sensor
2. Crumple detection system
3. Occupant detection system
4. Occupant safety sack set
5. Occupant knee lifter system
6. Seat push-back system
7. Seat tilting system

That each part is explained in the following:

### 1) Crash Sensor:

Crash sensors measure variables such as wheel speed, brake pressure, occupant condition, and increase in pressure to determine if the car is indeed experiencing a crash. Braking suddenly is not enough to trigger these sensors, because a combination of different factors is required. When the crash sensor determines that the car is indeed experiencing a crash, it sends signals to the ECU, causing it to deploy.

### Types of Crash Sensors:

Since the success of an airbag safety system relies on the crash sensors to work accurately and swiftly, the most technologically advanced and expensive part of the system is here. Crash sensors come in two types, electrical and mechanical.

### 2) Crumple Detection System:

Strain sensors are mounted on the body of the vehicle (FIG. 1), on both sides of the driver's and front passenger's legs, as well as on the front pillars. In the case of crashes that crumple the car or the pillar collides with an object, these sensors send crumple report to the ECU. In cases where only the pillar is crumbled (for example, rear-end collision with old trailers, with no reinforced rear impact guard), the knee lifter systems and front seat push-back system are activated accordingly and pushes the front seats back or Seat tilting system tilt the front seats.

### 3) Occupant Detection System:

It consists of a number of push sensors, which are mounted under the bottom of the seat, and into the seat structure, and compressed when sitting on a chair, and reports to ECU that there is an occupant in the seats other than the driver seat (FIG. 3). The sensor's report makes it possible for ECU to active occupant safety sack set and knee-high bags for present occupant when crashes, and do not activate the bags for empty chairs.

### 4) Occupant Safety Sack Set:

### 4-1) Occupant Safety Sack Set for Front Seat:

This type of safety sack is embedded in the roof of the car, and is composed of the following components (FIG. 2):
4-1-1) Guide rails: Guiding rails are mounted on the roof of the vehicle, and the safety sack set moves along, depending on whether the seat is suitable for the driver, or during the incident and seat move back.
4-1-2) Skid frame: The safety sack set is located on the skid frame, and the skid frame has this ability to move forward and backward in along the guide rails.
4-1-3) Airbag inflator gas generator: By ECU's airbag inflator gas generator, it triggers a combination of Sodium trinitride and potassium nitrate, and nitrogen gas is produced in fractions of seconds. The flow of nitrogen gas flows, blowing up the bags.
4-1-4) Safety sack expander airbags: After the explosion, the gas from the explosion first inflates the expander airbags.
4-1-5) Safety sack: The safety sack is made of nylon fibers and is coupled to the sack expander airbags, and at the time of the incident, expanded by the safety sack expander airbags and fully covers the passenger's upper limbs and back seat. The forces of a collision from the front enter the soft surface of the safety sack, and safety sack also prevent the hands of passenger from being thrown to the sides (FIG. 13). A mesh is embedded in the front of the passenger's face, so when the safety sack expanded the passenger can see the outside during the crash, and has no respiratory problem.
4-1-6) Airbag between the passenger and the door of the car, and airbag between the passengers: Nitrogen gas, after inflating safety sack expander airbags, enter into the airbags between the vehicle door and occupant, and airbag between two seats, and inflates these two airbags is on both sides of the passenger (FIG. 8). Inflation this air bag makes the safety sack tight around the passenger, and holds the passenger in place at the time of the accident, and also prevents the hands from being thrown around. In side crash, the responsibility of these airbags is to protect the upper limbs of occupant from the impact applied from the sides. It also surrounded around the neck and head of the occupant and prevents the head from being thrown around, at the time of the incident (FIG. 14). In the event of a car rollover, these air bags, by applying pressure on the shoulder of passengers, cause more passenger weight, apply on the shoulders, and much less pressure applies on the passenger's head and neck (FIG. 15). An outlet is intended to deactivate the gas inside the airbag faster, to open manually, and to release the airbag gas faster.
4-1-7) Top head airbags: After inflating the air bags around the occupant by nitrogen gas, it enters into bags above the head and causes it to inflate. In the event of a car rollover, the passenger's head collides with the soft surface of the airbag and prevents a passenger's collision with the car's roof (FIG. 15).

Setting safety sack set location on the roof of the vehicle should be such that, with the expanding of the safety sack, the safety sack can fully cover the upper occupant and the back of the seat. Adjustment of the air bag assembly is carried out manually or automatically. The method of operation of this device is that, after the accident detection by the crash sensor, and the accident report to the vehicle ECU, the ECU causes the airbag inflator gas generator to be activated. The nitrogen gas resulting from the reaction causes the safety sack expander airbags inflates, at a later stage, the gas inflates simultaneously the air bags between the passenger and the door of the car, and the airbag between the two seats and in the final step, it inflates an airbag overhead. The inflating of air bags between the passenger and the door of the car, and the airbag between the two seats in addition to protecting the passenger from side impacts makes the safety sack tight around the passenger's upper limb and keeps the passenger in place.

### 4-2) Occupant Safety Sack Set Rear Passengers:

Method of work of safety sack set for rear occupants, such as method of work of the front seats, except that the safety sack expander airbags inflate along the guide rail. The guide rail moves from the roof to down of the back seat (FIG. 15, 16). The guide rail is attached to the roof of the car and the side of the seat.

### 5) Occupant Knee Lifter System:

After reporting a car's crumple to the ECU by the strain gauge, the ECU active passenger's knee lifter system. The passenger knee system is in a variety of types, which we will continue to cover the specifications, advantages, and disadvantages of each of them.

### 5-1) Occupant Knee Lifter Airbag:

The airbag is mounted on the front of the bottom of seat (FIG. 3), and activated with the ECU's order of the vehicle, and raises the passenger's leg (FIG. 9). The high inflation rate of this airbag reduces the impact of the airbag inflation to the legs and waist, which can decrease the inflation rate by using a compressed gas cylinder, to fill the airbag rather than the gas produced by the chemical reaction.

A W-shaped airbag is used for the driver's seat, and the two seats behind the front seats, while lifting the passenger's legs, separates the passenger's legs from one another, so that they do not crash with the steering wheel or the front seat during an accident.

### 6) Seat Push-Back System:

The system consists of a telescopic pneumatic cylinder, fixed to the bottom of the car or fixed to fix part of the seat and is installed parallel to the seat guide rails that have the ability to quickly push the seat and the passenger back in the crash.

Method of work the system is that in heavy crash, the explosives inside the cylinder will explode, and the telescopic cylinder will be extended due to increased gas pressure and will collide with the seat slider handle for the push back system, and in addition to releasing the trigger of the seat, pushes the seat back, and the trigger locks at the end of the rail, and the locking seat gets in place.

The extended length of the hydraulic cylinder is that front seat does not create disturbances for the rear passenger at the last point of the rail (FIG. 18, FIG. 19).

### 7) Seat Tilting System:

The system consists of a telescopic pneumatic cylinder contain explosives inside, fixed to the seat structure and have the ability to quickly tilt the seat back and the passenger in the crash. If strain in pillars are greater than maximum strain (car collision with the back or side of a trailer), the ECU active seat tilting system quickly tilt the seat back and the passenger.

### V. Method of Work Occupant Protection System

Method of work of this invention is shown in FIG. 20.

1. A device defining an occupant safety sack set, embedded on roof of a car wherein at the time of the accident along with a seat back, covers the upper limb of an occupant and keeps the occupant in place and protects the occupant from shocks applied from front, back, sides and rollover.

2. The device according to claim 1, furthermore capable to move along with the seat.

3. The device according to claim 1, the occupant safety sack set further comprising:
one and second roof guide rails coupled to the roof of the car;
a skid frame having the ability to move along the roof guide rails;
an airbag inflator gas generator coupled to the skid frame;
a safety sack coupled to the skid frame;
a mesh embedded on the safety sack, in front the face of the occupant;
a plurality of safety sack expander airbags coupled to the safety sack and connected to the airbag inflator gas generator;
an airbag between the occupant and the door connected to the safety sack expander airbags;
an airbag between the occupants, connected to the safety sack expander airbags;
a top head airbag that connected to the airbag between the occupant and the door and the airbag between the occupants;
wherein at the time of the crash the airbag inflator gas, inflate the safety sack expander airbags and also expand the safety sack, then inflate the airbag between the occupant and the door and also the airbag between the occupants then inflate the top head airbags. at the time of the crash the safety sack along with the seat back, keeps the occupant in place and protects the occupant from shocks applied from front, back, sides and top. at the time of the car is tilted, the airbag between the occupant and the door along with the airbag between the occupants, apply force to the shoulders of the occupant and reduce the intensity of forces applied to the head and neck of the occupant.

4. The device according to claim 1, the occupant safety sack set further comprising:
one and second roof guide rails coupled to the roof of the car;
a skid frame having the ability to move along the roof guide rails;
an airbag inflator gas generator coupled to the skid frame;
a safety sack coupled to the skid frame;
a mesh embedded on the safety sack, in front the face of occupant;
a plurality of safety sack expander airbags coupled to the safety sack and connected to the airbag inflator gas generator;
an airbag between the occupant and the door connected to the safety sack expander airbags;
an airbag between the occupants connected to the safety sack expander airbags;
a top head airbag and connected to the airbag between the occupant and the door and the airbag between the occupants;
first and second side guide rails coupled to respective seat sides and coupled to the roof of the car;
a plurality of slider coupled to safety sack expander airbags and move along the side guide rails;
wherein the safety sack expander airbags are capable of inflating along the guide rails and the safety sack covers upper limb of the occupant, at the time of the accident or the car is tilted.

5. A device defining an occupant knee lifter wherein at the time of the accident, raises the occupant's legs in a short period of time.

6. The device according to claim 5, the occupant knee lifter comprising an airbag embedded on a seat bottom and is activated with a ECU command and raises the occupant's legs.

7. The device according to claim 5, the occupant knee lifter system comprising a U-shaped airbag embedded on edge of the seat bottom and is activated with a ECU command and raises the occupant's legs.

8. The device according to claim 5, the occupant knee lifter system comprising a W-shaped airbag embedded on edge of the seat bottom and is activated with a ECU command and rises and separates the occupant's legs.

9. A system defining occupant protection system in a crash comprising:
an ECU of a car;
one or a plurality of crash sensors;
a plurality of strain gauge attached to car chassis;
a plurality of strain gauge attached to the front pillars of the car;
a plurality of occupant safety sack sets;
a plurality of occupant sensors;
a plurality of occupant knee lifter systems;
a plurality of seat push-back systems;
a plurality of seat tilting systems;
wherein all the mentioned parts connected to the ECU of the car and at the time of the crash, the crash sensors feed the ECU, then ECU expand occupant safety sack sets and if the strain exceed over limit, the occupant knee lifter systems, raise the knee of occupants and the push back systems, move the seat back.

10. The system according to claim 9, the occupant safety sack set embedded on roof of car and at the time of the crash along with the seat back, keeps the occupant in place and protects the occupant from shocks applied from front, back, sides and rollover.

11. The system according to claim 9, the occupant safety sack sets comprising:
an airbag inflator gas generator;
a plurality of safety sack expander airbags;
a safety sack;
an airbag between the occupant and the door;
an airbag between the occupants;
a top head airbag;
wherein at the time of the crash the airbag inflator gas, inflate the safety sack expander airbags and expand the safety sack, then inflate the airbag between the occupant and the door and also the airbag between the occupants then inflate the top head airbags. at the time of the crash the safety sack along with the seat back, keeps the occupant in place and protects the occupant from shocks applied from front, back, sides and rollover. at the time of the car is tilted, the airbag between the occupant and the door along with the airbag between the occupants, apply force to the shoulders of the occupant and reduce the intensity of forces applied to the head and neck of the occupant.

12. The system according to claim 9, the occupant knee lifter system comprising an airbag embedded on the seat bottom that is activated with the ECU command and raises the occupant's legs.

13. The system according to claim 9, the occupant knee lifter system comprising a U-shaped airbag embedded on edge of the seat bottom and is activated with the ECU command and raises the occupant's legs.

14. The system according to claim 9, the occupant knee lifter system comprising a W-shaped airbag embedded on edge of the seat bottom that is activated with the ECU command and rises and separates the occupant's legs.

15. The system according to claim 9, the seat push-back system wherein at the time of the accident, push and move the seat backwards.

16. The system according to claim 9, the seat push-back system further comprising:
a pneumatic telescopic cylinder fixed to the frame of seat;
a seat slider handle;
a gas generator coupled inside the pneumatic telescopic cylinder, connected to the ECU;
wherein at the time of the crash, gas is released and extend the pneumatic telescopic cylinder and also push the seat back.

17. The system according to claim 9, the seat tilting system wherein at the time of the accident, tilts the back of the seat in a short period of time.

18. The system according to claim 9, the seat tilting system further comprising:
a pneumatic telescopic cylinder fixed to the frame of seat;
a seat adjuster;
a gas generator coupled inside the pneumatic telescopic cylinder, connected to the ECU;
wherein at the time of the crash, gas is released and extend the pneumatic telescopic cylinder and also tilt the seat back.
